(19) United States
(12) Patent Application Publication
(10) Pub. No.: US 2004/0137892 A1
(43) Pub. Date: Jul. 15, 2004

(54) Hand-held programmer and remote diagnostic interface device

(75) Inventor: Scott T. Hanood, Malvern, OH (US)

Correspondence Address: WOOD, HERRON & EVANS, LLP, 2700 CAREW TOWER, 441 VINE STREET, CINCINNATI, OH, 45202, US

(73) Assignee: JBS Technologies, LLC, Steubenville, OH

(21) Appl. No.: 10/752,053

(22) Filed: Jan. 6, 2004

Related U.S. Application Data
(60) Provisional application No. 60/438,246, filed on Jan. 6, 2003.

(51) Int. Cl. H04M 3/00; H04Q 7/20

(52) U.S. Cl. 455/418; 455/66.1; 455/423; 455/419; 455/569.2; 455/575.9; 455/41.2

(57) ABSTRACT

A hand-held programmer that is adapted to interface with a variety of vehicular accessories is disclosed. The device allows a user to preselect the desired settings for a particular accessory and then program that accessory with the push of a single button. The programmer also provides for an operable connection to a manufacturer's technical support computer via the Internet whereby software updates may be downloaded to the vehicular accessory and data for remote diagnostic troubleshooting may be exchanged between the manufacturer and the installer.

### CROSS-REFERENCE TO RELATED APPLICATION

The present application claims benefit of U.S. provisional application Serial No. 60/438,246, filed Jan. 6, 2003, the disclosure of which is hereby incorporated herein by reference in its entirety.

### FIELD OF THE INVENTION

The present invention relates to a system for programming vehicular accessories, e.g., a remote starter, and for remotely troubleshooting the same by providing a diagnostic interface to a technical support computer via the Internet.

### BACKGROUND OF THE INVENTION

Various vehicular accessories require a certain amount of programming upon installation. For example, an after-market remote starter that is installed in a motor vehicle can be programmed to start the vehicle when the outside temperature reaches a certain level. This programming is typically accomplished through the use of the activator associated with the accessory, such as a remote starter key fob. A certain button or combination of buttons on the fob must typically pressed, for a certain amount of time, while the number of parking light flashes are counted, to set the desired temperature at which the vehicle will automatically start.

Following such routines for establishing the settings of various vehicular accessories becomes more confusingly complex when multiple functions or settings must be programmed into a vehicular accessory, or when different vehicular accessories follow different programming sequences. In addition, once the settings are established, it may be burdensome to adjust a particular setting. Likewise, if a mistake is made in following the required programming routine, a user may have to start over due to the requirements of a particular vehicular accessory. In addition, a user may be forced to start over due the potentially confusing situation that may result when the programming sequence is interrupted.

Another problem associated with after-market accessories installed in motor vehicles is the ability for, or the ease at which, the software contained in these systems can be updated. Some vehicle accessories simply do not allow for the updating of the software contained in their memories. For other vehicle accessories that theoretically may be able to be updated, there is not a convenient way to provide such an update from the manufacturer.

Troubleshooting after-market vehicular accessories is another situation that can be particularly problematic. Different vehicles may present different situations requiring different installation procedures. In addition, a variety of installers may have varying degrees of experience and expertise in installing a particular manufacturer's product, which may lead to errors in the installation. While these errors can typically be remedied by the assistance of the manufacturer of the vehicular accessory, it is often not practical due to geographic, time, or money constraints, to seek the manufacturer's assistance. In addition, a user or installer may erroneously conclude that the after-market accessory is faulty, and return it to the manufacturer, when it was only programmed or installed wrong.

In sum, there is a need for being able to simply and conveniently program the settings of an after-market installed vehicular accessory. In addition, there is a need to be able to simply and conveniently update the software in a vehicular accessory from the manufacturer. There is also a need to be able to provide convenient and cost-effective assistance from a manufacturer in troubleshooting a vehicular accessory problems.

### OBJECTS OF THE INVENTION

It is an object of the applicant's invention to improve the convenience of initially programming an after-market installed vehicular accessory. It is also an objective of the applicant's invention to provide for the convenient updating of the software associated with a vehicular accessory. It is also an objective of the applicant's invention to improve the troubleshooting interaction between a manufacturer and an installer of after-market vehicular accessories.

### SUMMARY OF THE INVENTION

The present invention achieves these objectives by use of a hand-held programmer that is adapted to interface with a variety of vehicular accessories. The present invention allows a user to preselect the desired settings for a particular accessory, and then program that accessory with the push of a single button. The programmer of the present invention also provides for an operable connection to a manufacturer's technical support computer via the Internet whereby software updates may be downloaded to the vehicular accessory and data for remote diagnostic troubleshooting may be exchanged between the manufacturer and the installer.

The above and other objects and advantages of the present invention shall be made apparent from the accompanying drawings and the descriptions thereof.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is an perspective view of an embodiment of a programmer of the present invention.

FIG. 2A is an illustration of an embodiment of the present invention where a programmer is operatively connected to a vehicular accessory.

FIG. 2B is an illustration of an embodiment of the present invention where a programmer is operatively connected to a vehicular accessory via a vehicular antenna.

FIG. 2C is an illustration of an embodiment of the present invention where a programmer is operatively connected to a vehicular accessory and operatively connected to a technical support computer via a local computer and the Internet.

### DETAILED DESCRIPTION OF THE INVENTION

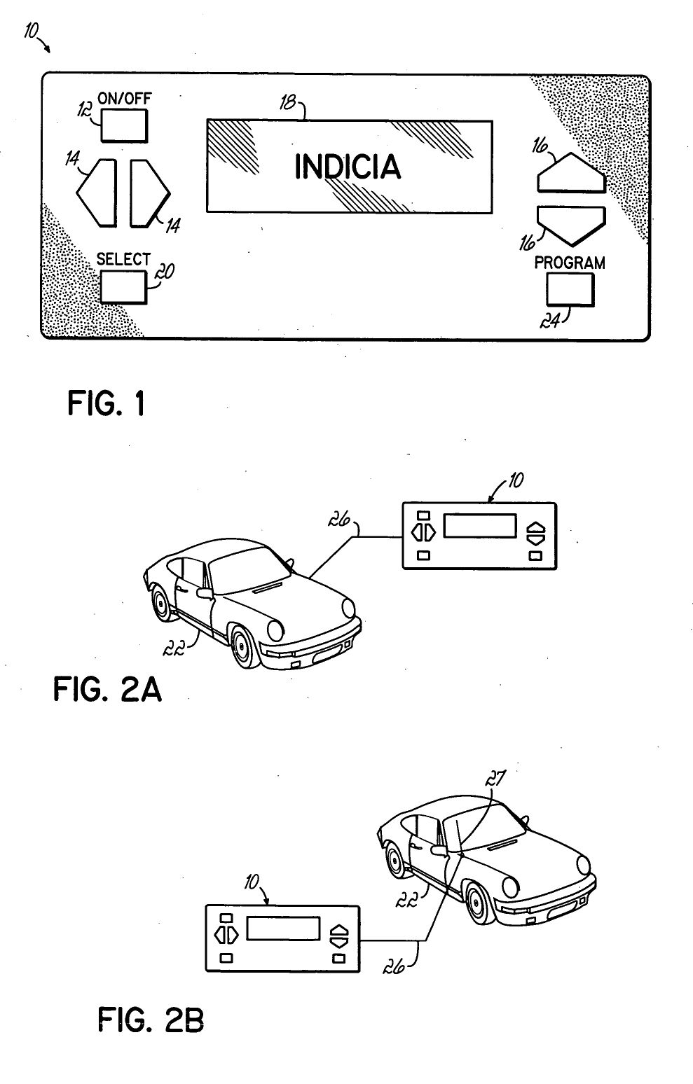

An embodiment of a programmer 10 according to the principles of the present invention is shown in FIG. 1. The programmer 10 contains an ON/OFF switch button 12, directional menu selection buttons 14, and directional buttons 16 for scrolling through an LED display 18. Another switch button 20 allows a user to select the desired setting for a particular function of an accessory for a motor vehicle 22. When all of the desired settings are selected, the programmer 10 provides a program switch button 24 whereby the settings are transmitted from the programmer 10 to the motor vehicle 22 accessory.

It can be appreciated that while a certain number, configuration, and orientation of buttons 12, 14, 16, 20, 24 are shown in the programmer 10 of FIG. 1, that a variety of input and/or selection interface systems could also be used in accordance with the principles of the present invention. For example, a touch pad or touch screen could replace the LED display 18 and could further eliminate some or all of the buttons. In addition, a voice recognition module could be contained in the programmer 10 allowing a user to make his or her selections by voice command. Similarly, the programmer 10 could contain a speaker for providing voice prompts to a user in lieu of or in addition to the visual display 18.

Preferably the programmer 10 is of a size and weight to allow for hand-held operation. In addition the programmer may contain its own power source, such as standard replaceable batteries, a rechargeable battery, or even power generating solar cells. It may also contain a connection to receive power from a household current.

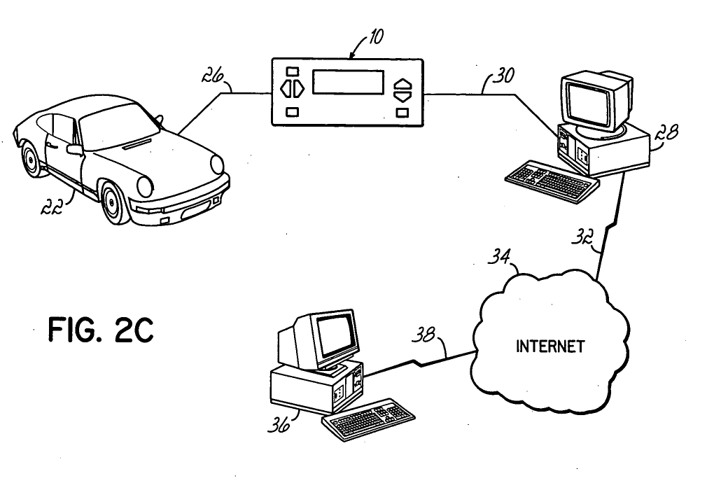

As shown in FIGS. 2A-2B, the programmer 10 may be operatively connected to the accessory of a motor vehicle 22 via a cable 26. The cable 26 could be a wire leading to a windshield mounted antenna, could be connected directly to the vehicle's antenna 27, or could be the vehicle's antenna 27. It should be appreciated, however, that other methods of operatively connecting the programmer 10 to the vehicular accessory may be used. For example, wireless transmission of data between the program 10 and the vehicle 22 may be accomplished using (IR) or radio frequency (RF) or the like. In sum, it should be appreciated that the after-market installed vehicular accessory does not necessarily have to be removed from the vehicle 22 to be placed in operable connection with the programmer 10.

FIG. 2C shows the programmer 10 operatively connected via a cable 26 to the vehicle 22 and also operatively connected to a personal computer (PC) 28 via a cable 30. The PC 28 is located at the installer's place of business and provides a link 32 via a cable modem or the like to the Internet 34. It should be appreciated that the programmer 10 could be wirelessly connected to the PC 28 via an IR, RF, optical or other like connection. In addition, in an alternative embodiment the programmer 10 may be directly connected to the Internet 34 via an internal modem and/or modem and cellular or cordless telephone.

As also shown in FIG. 2C, the programmer 10 is operatively connected to a technical support computer 36 which is linked 38 to the Internet 34 via a cable modem or the like. In the preferred embodiment the technical support computer 36, which may also be a PC, is located at the manufacturer's technical support location. While a single technical support computer 36 is shown, it can be appreciated that a plurality of technical support computers 36 could be utilized and that these computers could be geographically dispersed.

The operable connection of the a vehicular accessory via the programmer 10 to a manufacturer's technical support computer 36 provides for a multitude of capabilities. For example, new software can be downloaded from the manufacturer's computer 36 to update the software contained in the accessory. To make the process even easier, it can be appreciated that the software could first be downloaded and stored in the programmer 10 and then subsequently transmitted to the vehicle 22. In other words, an installer could connect once to a manufacturer's computer 36 via the Internet 34 and get all the updates for a variety of accessories. Then as then need arose, the hand-held programmer 10 could update the software of the vehicular accessories (e.g., flash the new software to the accessory), regardless of whether the programmer 10 was connected to a PC 28 or the Internet 34.

In addition, operable connection of a vehicular accessory via the programmer 10 to the manufacturer's technical support computer 36 provides for two-way communication and telemetry troubleshooting. The manufacturer will be able to remotely run diagnostics on the vehicular accessory from its home office. Determinations could be made that the problem lies in the installation, the wiring set-up, or programming, or the accessory itself. In addition, the manufacturer could even program the accessory remotely.

Finally, the reader should appreciate that the present invention also encompasses a method for programming vehicular accessories comprising the steps of selecting the desired settings for the vehicular accessories in a programmer via a user interface comprising a button activated LED display and a plurality of function buttons, connecting the programmer to the vehicular accessories via a vehicular accessory interface, and downloading, with the push of a single button, the desired settings for the vehicular accessories from the programmer to the vehicular accessories. In addition, the present invention also encompasses a method for updating the software of vehicular accessories comprising the steps of connecting the programmer to the Internet via an Internet interface, downloading from a technical support computer operatively connected to the Internet new software for the vehicular accessories, connecting the programmer to the vehicular accessories via a vehicular accessory interface, and downloading the new software for the vehicular accessories from the programmer to the vehicular accessories. Finally, the present invention also encompasses a method for troubleshooting vehicular accessories comprising the steps of connecting the programmer to the vehicular accessories via a vehicular accessory interface, connecting the programmer to the Internet via an Internet interface, transmitting data from the vehicular accessories to a technical support computer via the programmer and the Internet, and transmitting data from the technical support computer to the vehicular accessories via the Internet and the programmer.

While the present invention has been illustrated by a description of various embodiments and while these embodiments have been described in considerable detail, it is not the intention of the applicant to restrict or in any way limit the scope of the claims to such detail. Additional advantages and modifications will readily appear to those skilled in the art. The invention in its broader aspects is, therefore, not limited to the specific details, representative apparatus and method, and illustrative examples shown and described. Accordingly, departures may be made from such details without departing from the spirit or scope of the applicant's general inventive concept.

What is claimed is:

1. A system for programming and troubleshooting vehicular accessories comprising:
a programmer with memory and a user interface whereby the programmer's functions may be selected; and
a vehicular accessory interface operatively coupled to the programmer whereby data may be exchanged between the programmer and the vehicular accessories.

2. The system of claim 1 wherein the user interface comprises a button activated LED display and a plurality of function buttons.

3. The system of claim 1 wherein the vehicular accessory interface is bidirectional.

4. The system of claim 1 wherein the vehicular accessory interface comprises a cable.

5. The system of claim 1 wherein the vehicle accesory interface comprises a vehicular antenna.

6. The system of claim 1 wherein the vehicular accessory interface is wireless.

7. The system of claim 6 wherein the wireless vehicular accessory interface is an infra-red (IR) connection.

8. The system of claim 6 wherein the wireless vehicular accessory interface is a radio frequency (RF) connection.

9. The system of claim 1 further comprising an Internet interface operatively coupled to the programmer.

10. The system of claim 9 wherein the Internet interface is bidirectional.

11. The system of claim 9 wherein the Internet interface comprises a cable.

12. The system of claim 9 wherein the Internet interface is wireless.

13. The system of claim 9 wherein the wireless Internet interface is an infra-red (IR) connection.

14. The system of claim 9 wherein the wireless Internet interface is a radio frequency (RF) connection.

15. The system of claim 1 further comprising a technical support computer operatively connected to Internet and adapted to send data to and receive data from the programmer via the Internet.

16. A system for programming and troubleshooting vehicular accessories comprising:
a programmer with memory and a user interface comprising a button activated LED display and a plurality of function buttons whereby the programmer's functions may be selected;
a vehicular antenna;
a bidirectional vehicular accessory interface cable operatively coupled to the antenna and to the programmer whereby data may be exchanged between the programmer and the vehicular accessories;
a bidirectional Internet interface cable operatively coupled to the programmer; and
a technical support computer operatively connected to Internet and adapted to send data to and receive data from the programmer via the Internet.

17. A system for programming and troubleshooting vehicular accessories comprising:
a means for programming and troubleshooting vehicular accessories;
a means for allowing a user to control the means for programming;
a means for operatively connecting the means for programming to the vehicular accessories;
a means for operatively connecting the means for programming to the Internet; and
a means for storing data, sending data to, and receiving data from the programmer via the Internet.

18. A method for programming and troubleshooting vehicular accessories comprising:
selecting the desired settings for the vehicular accessories in a programmer via a user interface comprising a button activated LED display and a plurality of function buttons;
connecting the programmer to the vehicular accessories via a vehicular accessory interface; and
downloading the desired settings for the vehicular accessories from the programmer to the vehicular accessories.

19. The method of claim 18 wherein the downloading of the desired settings is activated by the pushing of a single button.

20. A method for programming and troubleshooting vehicular accessories comprising:
connecting the programmer to the Internet via an Internet interface;
downloading from a technical support computer operatively connected to the Internet new software for the vehicular accessories;
connecting the programmer to the vehicular accessories via a vehicular accessory interface; and
downloading the new software for the vehicular accessories from the programmer to the vehicular accessories.

21. A method for programming and troubleshooting vehicular accessories comprising:
connecting the programmer to the vehicular accessories via a vehicular accessory interface;
connecting the programmer to the Internet via an Internet interface;
transmitting data from the vehicular accessories to a technical support computer via the programmer and the Internet; and
transmitting data from the technical support computer to the vehicular accessories via the Internet and the programmer.
